(19) United States
(12) Patent Application Publication
(10) Pub. No.: US 2008/0123350 A1
(43) Pub. Date: May 29, 2008

(54) LIGHT GUIDE UNIT AND BACKLIGHT UNIT AND DISPLAY DEVICE USING THE LIGHT GUIDE UNIT

(75) Inventors: Kyu-min CHOE, Suwon-si (KR); Moon-gyu Lee, Suwon-si (KR); Jee-hong Min, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/830,165

(22) Filed: Jul. 30, 2007

(30) Foreign Application Priority Data
Nov. 29, 2006 (KR) 10-2006-0119125

(51) Int. Cl. F21V 13/04; F21V 5/00

(52) U.S. Cl. 362/331; 362/330; 362/327

(57) ABSTRACT

A light guide unit and a backlight unit and display device using the light guide unit are provided. The light guide unit includes a light guide body that is formed of a transparent material and has at least one concave portion with a concavely depressed bottom surface to accommodate a light source. The light guide body includes a first incidence surface forming a top surface of the concave portion, the first incidence surface patterned such that upwardly incident light is refracted at an oblique angle in a lateral direction; a second incidence surface forming a lateral surface of the concave portion, the second incidence surface to which lateral light is incident; a reflection surface disposed on a bottom surface of the light guide body, which extends from the concave portion; and a refraction surface forming a top surface of the light guide body, the refraction surface through which incident light is refracted and transmitted. The use of the above-described light guide unit leads to a rise in optical efficiency. Also, the backlight unit using the light guide unit can effectively collimate light on a large area and increase a contrast ratio.

### CROSS-REFERENCE TO RELATED PATENT APPLICATIONS

This application claims priority from Korean Patent Application No. 10-2006-0119125, filed on Nov. 29, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a light guide unit and a backlight unit and display device using the light guide unit and, more particularly, to a light guide unit, which is structurally improved to irradiate collimated light, and backlight unit and display device using the light guide unit.

2. Description of the Related Art

A liquid crystal display (LCD), which is a kind of flat panel display (FPD), is fabricated by disposing two substrates including light emission electrodes, respectively, such that surfaces of the substrates on which the electric field generation electrodes are formed face each other, and injecting liquid crystals (LCs) between the two substrates. By moving LC molecules due to an electric field generated by a voltage applied between the two electrodes, the polarization of light is changed between polarizers disposed on both sides of the substrate and leads to a variation in the transmission rate of light, so that the LCD creates an image depending on the transmission rate of light.

Since the LCD is not an emissive display but controls only the transmission rate of light, the LCD requires an additional light source. Thus, a backlight unit is disposed on a rear surface of an LC panel, and light emitted from the backlight unit is incident on the LC panel, so that the LCD controls the quantity of transmitted light according to the arrangement of LCs to display an image.

The backlight unit may be classified into a direct light type and an edge light type. The direct light type backlight unit includes a light source disposed on a bottom surface of an LC panel to directly irradiate light to the entire surface of a substrate. The direct light type backlight unit is suitable for large-sized displays, such as LCD-TVs since a light source can be disposed freely and effectively in a large area. In contrast, the edge light type backlight unit includes a light source disposed on one side or both sides of a substrate to reflect and diffuse light by use of a light guide panel or reflection plate. The edge light type backlight unit is suitable for medium- and small-sized displays, such as monitors, portable phones and portable computers, since the position of a light source is restricted to an edge of a light guide panel.

An LC panel functions as a shutter to pass or cut off the light by changing the polarization of straight polarized light. Accordingly, if a variation in the polarization of light varies with a direction in which light is incident, the quantity of transmitted light is not uniform, so that a contrast ratio depends on a direction in which a user views the LC panel. In a conventional LCD, since light irradiated from a backlight unit to the LC panel is normally diffused light, a variation in the polarization of light that is incident on an LC panel varies, and thus a contrast ratio is changed according to a direction in which a user views the LC panel. Even if a reduction in the contrast ratio is controlled using a phase difference film, an LCD of which the view angle is 170° has a contrast ratio of several ten thousands to 1 from the front view, while it has a contrast ratio of 10 to 1 at an angle of 85° from the left and right views. As a result, an LCD in which diffused light is irradiated to an LC panel suffers from the degradation of quality at a large angle.

Further, in order to secure a sufficient view angle, a compensation film for the angular field of view may be employed or various LC modes including an In Plane Switching (IPS) mode, a Vertical Alignment (VA) mode, and an Optical Compensation Bend (OCB) mode, may be adopted to compensate a variation in polarization according to an angle. However, the above-described methods lead to a decrease in an aperture ratio and an increase in the number of required fabrication processes, thus bringing about a rise in fabrication cost.

### SUMMARY OF THE INVENTION

Exemplary embodiments of the present invention provide a light guide unit, which collimates light from a light source and guides the collimated light to increase the quantity of light emitted in a vertical direction, and a backlight unit and display device using the light guide unit.

According to an aspect of the present invention, there is provided a light guide unit including a light guide body that is formed of a transparent material and has at least one concave portion with a concavely depressed bottom surface to accommodate a light source. The light guide body includes: a first incidence surface forming a top surface of the concave portion, the first incidence surface patterned such that upwardly incident light is refracted at an oblique angle in a lateral direction; a second incidence surface forming a lateral surface of the concave portion, the second incidence surface to which lateral light is incident; a reflection surface disposed on a bottom surface of the light guide body, which extends from the concave portion; and a refraction surface forming a top surface of the light guide body, the refraction surface through which incident light is refracted and transmitted.

According to another aspect of the present invention, there is provided a backlight unit including a light source that irradiates light; and at least one light guide unit that collimates the light irradiated by the light source to perform surface-illumination and including a light guide body, which is formed of a transparent material and has at least one concave portion with a concavely depressed bottom surface to accommodate the light source; and a collimating member that collimates the light transmitted through the light guide body. The light guide body includes: a first incidence surface forming a top surface of the concave portion, the first incidence surface patterned such that upwardly incident light is refracted at an oblique angle in a lateral direction; a second incidence surface forming a lateral surface of the concave portion, the second incidence surface to which lateral light is incident; a reflection surface disposed on a bottom surface of the light guide body, which extends from the concave portion; and the refraction surface forming a top surface of the light guide body, a refraction surface through which incident light is refracted and transmitted.

According to another aspect of the present invention, there is provided a display device including a display panel for creating an image; and a backlight unit prepared on a rear surface of the display panel to irradiate collimated light on the display panel. The backlight unit includes: a light source that irradiates light; and at least one light guide unit that collimates the light irradiated by the light source to perform surface-illumination and including a light guide body, which is formed of a transparent material and has at least one concave portion with a concavely depressed bottom surface to accommodate the light source; and a collimating member that collimates the light transmitted through the light guide body. The light guide body includes: a first incidence surface forming a top surface of the concave portion, the first incidence surface patterned such that upwardly incident light is refracted at an oblique angle in a lateral direction; a second incidence surface forming a lateral surface of the concave portion, the second incidence surface to which lateral light is incident; a reflection surface disposed on a bottom surface of the light guide body, which extends from the concave portion; and a refraction surface forming a top surface of the light guide body, the refraction surface through which incident light is refracted and transmitted.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is an exploded perspective view of a light guide unit and a backlight unit using the same, according to an exemplary embodiment of the present invention;

FIG. 2 is a lateral view of the backlight unit shown in FIG. 1;

FIG. 3 is a magnified view of portion “A” of FIG. 2, which illustrates a light transmission path in the light guide body of FIG. 2;

FIG. 4 is a lateral view of a light guide unit and a backlight unit using the same, according to another exemplary embodiment of the present invention;

FIG. 5 is an exploded perspective view of a light guide unit and a backlight unit using the same, according to still another exemplary embodiment of the present invention;

FIG. 6 is a lateral view of the backlight unit shown in FIG. 5;

FIG. 7 is a diagram showing a modified example of the light guide unit shown in FIG. 5;

FIG. 8 is a lateral view of a light guide unit and a backlight unit using the same, according to yet another exemplary embodiment of the present invention; and

FIG. 9 is a lateral view of a display device according to an exemplary embodiment of the present invention.

### DETAILED DESCRIPTION OF EXEMPLARY EMBODIMENTS OF THE INVENTION

A light guide unit and a backlight unit and display device using the light guide unit consistent with the present invention will now be described more fully hereinafter with reference to the accompanying drawings, in which exemplary embodiments of the invention are shown.

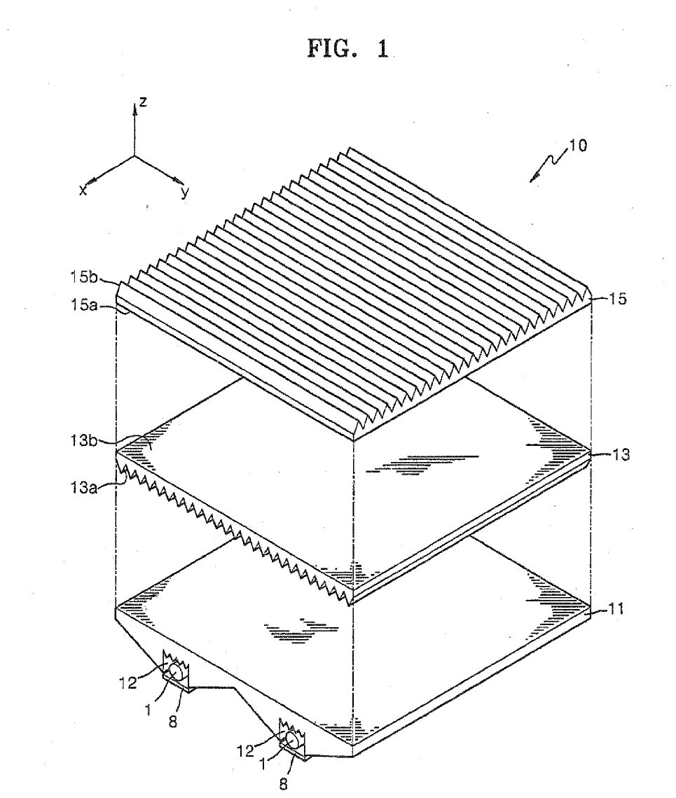

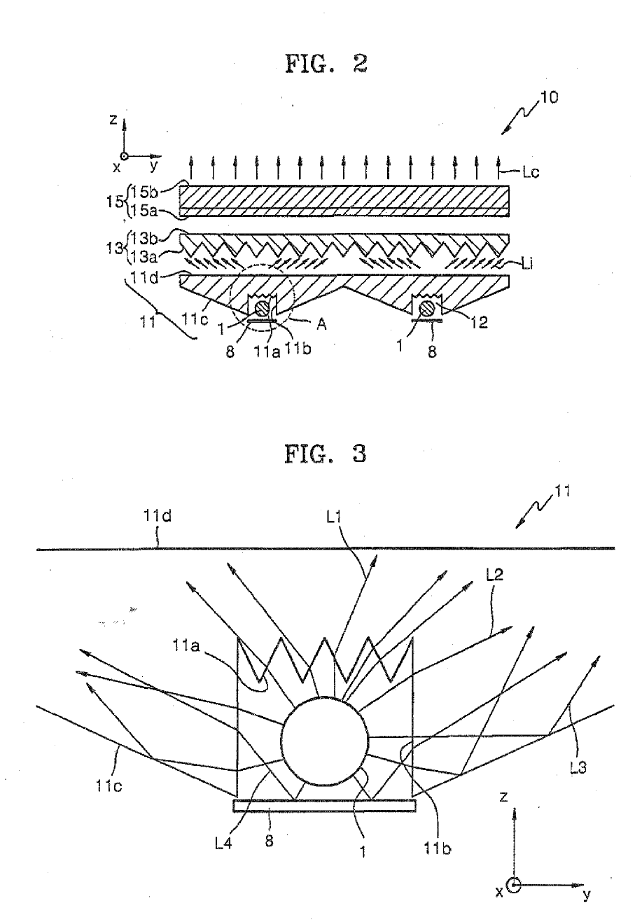

FIG. 1 is an exploded perspective view of a light guide unit and a backlight unit using the same, according to an exemplary embodiment of the present invention, and FIG. 2 is a lateral view of the backlight unit shown in FIG. 1.

Referring to FIGS. 1 and 2, the backlight unit of the present embodiment includes a plurality of line light sources 1, which irradiate light, and a light guide unit 10, which collimates the light irradiated by the line light sources 1 and performs surface-illumination. In the drawings, an x direction refers to a lengthwise direction of the line light source 1, while a z direction refers to a direction normal to a light emission surface of the light guide unit 10.

In the present exemplary embodiment, the line light source 1 may be, for example, a cold cathode fluorescent lamp (hereinafter, CCFL).

The light guide unit 10 includes a light guide body 11, which accommodates the line light sources 1, and a collimating member, which includes a reverse prism sheet 13 and a forward prism sheet 15 and collimates light transmitted through the light guide body 11.

The light guide body 11 may be formed of a transparent material that transmits incident light. For example, the light guide body 11 may be formed of poly methyl methacrylate (PMMA), which is a plastic material having a high optical transmission rate and good weatherability.

The light guide body 11 includes concave portions 12, each of which has a concavely depressed bottom surface to accommodate the corresponding line light source 1. The concave portion 12 forms a long groove so that the line light source 1, such as a CCFL, can be installed in the concave portion 12. In the present exemplary embodiment, since a plurality of line light sources 1 may be installed, the concave portions 12 may be prepared in a number equal to the number of line light sources 1. By installing the line light source 1 in the concave portion 12, loss of light can be minimized.

As best shown in FIGS. 2 and 3, a top surface of the concave portion 12 forms a first incidence surface 11a of the light guide body 11, and a lateral surface of the concave portion 12 forms a second incidence surface 11b thereof. The first incidence surface 11a is a surface to which upward light of light emitted by the line light source 1 is incident, while the second incidence surface 11b is a surface to which lateral light of the light emitted by the line light source 1 is incident. In this case, “upward” refers to a direction normal to a refraction surface 11d (i.e., the z direction), and “lateral” refers to a direction that largely leans in a ±y direction to the normal direction. The first incidence surface 11a is patterned such that incident light is refracted at an oblique angle in a lateral direction. For example, the first incidence surface 11a may be patterned such that a plurality of long prisms are arranged in a lengthwise direction of the concave portion 12 (i.e., the x direction).

Also, a bottom surface of the light guide body 11, which extends from the concave portion 12, forms a reflection surface 11c. The reflection surface 11c is aslant to the refraction surface 11d to reflect incident light toward the refraction surface 11d. In other words, a portion outside of the concave portion 12 of the light guide body 11 is formed in a wedge shape so that a distance between the reflection surface 11c and the refraction surface 11d is greater in a region close to the concave portion 12 than in a region far from the concave portion 12. The reflection surface 11c may be reflective-coated to increase a reflection effect. The reflection surface 11c may have a saw-toothed sectional shape or other various patterns to make lateral reflection effective.

A top surface of the light guide body 11 forms the refraction surface 11d through which light is refracted and transmitted. An emission pattern may be formed on the refraction surface 11d such that light is refracted and transmitted through the refraction surface 11d at an oblique angle. Further, the emission pattern may be formed such that light guided by the light guide body 11 in a lateral direction is reflected by the refraction surface 11d and goes out of the light guide body 11 instead of going into the light guide body 11. The emission pattern in the refraction surface 11d may be formed as a grating or hologram type. Specifically, the emission pattern may be a prism pattern having prism-type grooves, a scattering pattern having concave protrusions, or a blazed pattern having blazed grooves.

A reflection member 8 is disposed at the bottom surface of the light guide body 11 and reflects downward light of the light emitted by the line light source 1 toward the first and second incidence surfaces 11a and 11b. Since the line light source 1 is installed in the concave portion 12, the reflection member 8 is disposed to cover the concave portion 12 that accommodates the line light source 1.

FIG. 3 is a magnified view of portion “A” of FIG. 2, which illustrates a light transmission path in the light guide body 11 of FIG. 2.

Referring to FIG. 3, the line light source 1, such as a CCFL, emits light in a cylindrically symmetrical manner. Upward light L1 of the emitted light is incident to the first incidence surface 11a, which is patterned to have downwardly protruding prisms as illustrated in FIG. 3. Thus, the upward light L1 is refracted at an oblique angle in a lateral direction and incident to the first incidence surface 11a. Meanwhile, lateral light L2 and L3 is incident to the second incidence surface 11b. After being incident to the second incidence surface 11b, partial lateral light L2 directly travels toward the refraction surface 11d, while the remaining lateral light L3 is reflected by the reflection surface 11c and travels toward the refraction surface 11d. Most of the light that travels toward the refraction surface 11d is transmitted through the refraction surface 11d and goes in a lateral direction. Part of the light that travels toward the refraction surface 11d is totally reflected due to a difference in refractive index between the light guide body 11 and the air outside, goes inward, is reflected by the reflection surface 11c again, and transmitted through the refraction surface 11d. Downward light L4 of the light emitted by the line light source 1 is reflected by the reflection member 8, incident to the first incidence surface 11a or the second incidence surface 11b, and transmitted through the refraction surface 11d.

As described above, since upwardly directed light of the light emitted by the line light source 1 or the light reflected by the reflection member 8 is refracted by the first incidence surface 11a at a large angle in a lateral direction, it is emitted by the light guide unit 11 in a lateral direction. In this case, the upward light is dispersed in a lateral direction, so that optical intensity is not concentrated near the line light source 1 but distributed in a wide range. Lateral light of the light emitted by the line light source 1, which is incident through the second incident surface 11b, is generally emitted at an angle that varies within a small range, so that it is emitted in a lateral direction.

Referring again to FIGS. 1 and 2, light emitted by the light guide body 11 in a lateral direction is collimated upward by the collimating member.

The collimating member includes the reverse prism sheet 13 and the forward prism sheet 15.

The reverse prism sheet 13 is disposed close to the refraction surface 11d of the light guide body 11 and has a light incidence surface 13a on which a plurality of linear reverse prisms are formed. In other words, the reverse prism sheet 13 is disposed such that the light incidence surface 13a having the linear reverse prisms faces the refraction surface 11d of the light guide body 11. In this case, the reverse prism sheet 13 is disposed such that a lengthwise direction of the linear reverse prisms is the same as the lengthwise direction of the concave portion 12 (i.e., the x direction).

Light that is incident on the reverse prism sheet 13 at an oblique angle in a ±y direction is collimated in a z direction by the linear reverse prism formed on the light incidence surface 13a of the reverse prism sheet 13. In other words, light emitted by the long line light source 1 in the x direction is tilted at a large angle in the +y direction through the light guide body 11 and then collimated by the reverse prism sheet 13 in the z direction.

Meanwhile, part of the light transmitted through the light guide body 11, which is tilted in a ±x direction, is collimated by the forward prism sheet 15.

The forward prism sheet 15 is disposed close to a light emission surface 13b of the reverse prism sheet 13. The forward prism sheet 15 includes a plurality of linear forward prisms formed on the light emission surface 15b. In other words, the forward prism sheet 15 is disposed such that the light emission surface 15b on which the linear forward prisms are formed is the reverse side of a light incidence surface 15a that faces the reverse prism sheet 13. In this case, the forward prism sheet 15 is disposed such that a lengthwise direction of the linear forward prisms is perpendicular to the linear reverse prisms of the reverse prism sheet 13 (i.e., the y direction). Light that is incident on the forward prism sheet 15 at an oblique angle in a ±x direction is collimated in a z direction by the linear forward prism formed on the light emission surface 15b of the forward prism sheet 15.

The direction of emission light may be indicated by an azimuth, which refers to an angle that the emission light makes with a normal line (i.e., a z-axis) to a light emission surface of the light guide unit 10. In the present exemplary embodiment, the collimating member shifts the distribution of azimuths of light Li emitted by the light guide body 11 such that light Lc transmitted through the light guide unit 10 is within a predetermined range of azimuth (see FIG. 2). In other words, in the present exemplary embodiment, light that is tilted in the +y direction is collimated in the z direction by the reverse prism sheet 13, and light that is tilted in the ±x direction is collimated in the z direction by the forward prism sheet 15, so that the quantity of light emitted in a vertical direction can increase. For example, light Lc transmitted through the light guide unit 10 may be collimated such that a half-power angle is within 10° with respect to the normal line to the light emission surface. Here, the half-power angle refers to an azimuth of light at which optical intensity is halved. As will be described later, when light with a large azimuth is incident to a display panel, such as a liquid crystal (LC) panel, the light greatly varies a contrast ratio according to a view direction. Thus, the light with the large azimuth affects an adjacent pixel to generate crosstalk, so that an aperture ratio cannot be sufficiently increased. However, the present invention can restrict an azimuth of light Lc transmitted through the light guide unit 10 within a predetermined range, thus improving the contrast ratio of a display panel.

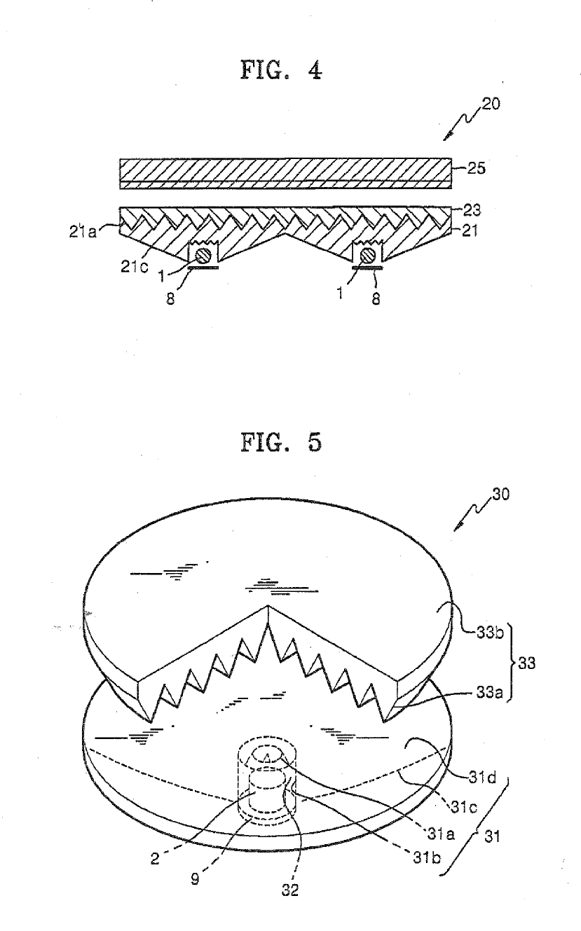

FIG. 4 is a lateral view of a light guide unit and a backlight unit using the same, according to another exemplary embodiment of the present invention.

Referring to FIG. 4, the backlight unit of the present exemplary embodiment includes a plurality of line light sources 1, a light guide unit 20, which collimates light irradiated by the line light sources 1 and performs surface-illumination, and a reflection member 8. The light guide unit 20 includes a light guide body 21, which accommodates the light guide sources 1, a reverse prism sheet 23, and a forward prism sheet 25.

In the light guide unit 20 of the present exemplary embodiment, the light guide body 21 and the reverse prism sheet 23 are formed as an integral type. Specifically, a refraction surface 21a of the light guide body 21 has a complementary shape to a pattern of the reverse prism sheet 23 so that the light guide body 21 and the reverse prism sheet 23 are in mesh and adhered closely to each other. The close adhesion of the light guide body 21 to the reverse prism sheet 23 may be accomplished by, for example, forming a linear forward prism pattern on the refraction surface 21a of the light guide body 21 and forming the reverse prism sheet 23 using a direct molding process. In this case, when light is transmitted from the light guide body 21 to the reverse prism sheet 23, the refractive index of the reverse prism sheet 23 may be higher than that of the light guide body 21 in order to prevent total reflection of the light.

As described above, by integrally forming the light guide body 21 and the reverse prism sheet 23, the total reflection of light transmitted from the refraction surface 21a of the light guide body 21 can be prevented. Further, the number of components assembled can be reduced, thus simplifying an assembling process of the backlight unit.

The light guide unit 20 of the present exemplary embodiment is substantially the same as the light guide unit shown in FIGS. 1 through 3 except that the light guide body 21 is combined with the reverse prism sheet 23. Therefore, a description of the remaining components will be omitted here.

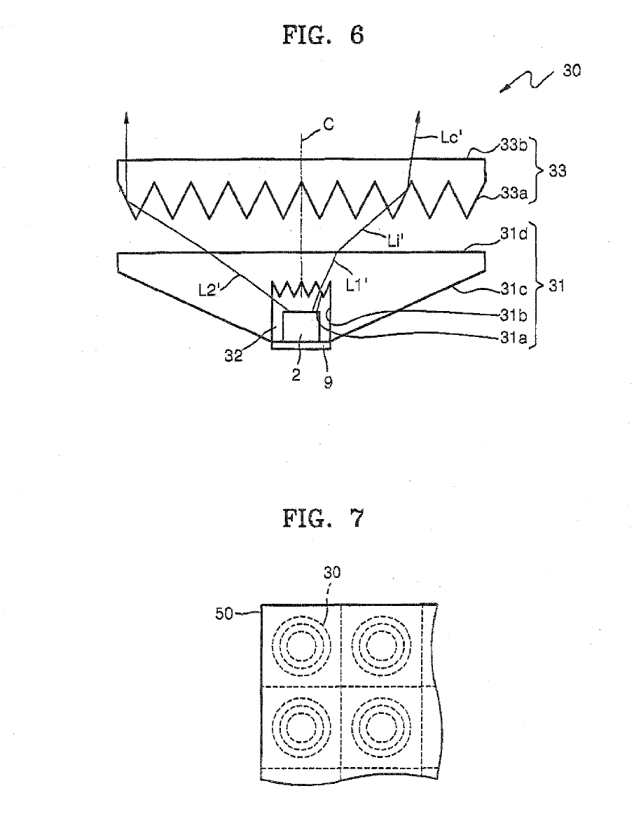

FIG. 5 is an exploded perspective view of a light guide unit and a backlight unit using the same, according to still another exemplary embodiment of the present invention, and FIG. 6 is a lateral view of the backlight unit shown in FIG. 5.

Referring to FIGS. 5 and 6, the backlight unit of the present exemplary embodiment includes a point light source 2, which irradiates light, and a light guide unit 30, which collimates light irradiated by the point light source 2 and performs surface-illumination.

In the present exemplary embodiment, the point light source 2 may be an emission device, for example, a light emitting diode (LED).

The light guide unit 30 includes a light guide body 31, which accommodates the point light source 2, and an annular reverse prism sheet 33, which collimates light emitted by the light guide body 31.

The light guide body 31 and the annular reverse prism sheet 33 may be circularly symmetric with respect to the central axis C of the point light source 2 (see FIG. 6). However, the present invention is not limited thereto, and, for example, outer portions of the light guide body 31 and the annular reverse prism sheet 33 may be designed as rectangular types so that the light guide body 31 and the annular reverse prism sheet 33 can be used for a rectangular backlight unit.

The light guide body 31 may be formed of PMMA, which is a plastic material having a high optical transmission rate and good weatherability.

The light guide body 31 includes a concave portion 32, which has a concavely depressed bottom surface to accommodate the point light source 2. The concave portion 32 forms a cylindrical groove or a polygonal columnar groove so that the point light source 2, such as an LED, can be installed in the concave portion 32. By installing the point light source 2 in the concave portion 32, even light emitted in a lateral direction can be guided to increase optical efficiency.

A top surface of the concave portion 32 forms a first incidence surface 31a of the light guide body 31, and a lateral surface of the concave portion 32 forms a second incidence surface 31b thereof. The first incidence surface 31a is a surface to which upward light of light emitted by the point light source 2 is incident, while the second incidence surface 31b is a surface to which lateral light of the light emitted by the point light source 2 is incident. The first incidence surface 31a is patterned such that incident light is refracted at an oblique angle in a lateral direction. For example, the first incidence surface 31a may be patterned such that a plurality of annular prisms, which protrude downward, are arranged as a concentric circular type.

Also, a bottom surface of the light guide body 31, which extends from the concave portion 32, forms a reflection surface 31c. The reflection surface 31c is aslant to a refraction surface 31d to reflect incident light toward the refraction surface 31d. In other words, a portion outside of the concave portion 32 of the light guide body 31 is formed in a wedge shape so that a distance between the reflection surface 31c and the refraction surface 31d is greater in a region close to the concave portion 32 than in a region far from the concave portion 32. The reflection surface 31c may be reflective-coated to increase a reflection effect.

A top surface of the light guide body 31 forms the refraction surface 31d through which light is refracted and transmitted. The refraction surface 31d may be patterned such that light is refracted and transmitted at an oblique angle in a lateral direction. The pattern formed on the refraction surface 31d may be, for example, a pattern in which a plurality of wedge-shaped annular prisms are arranged in a concentric circular shape, or a hologram pattern.

A reflection member 9 is disposed at the bottom surface of the light guide body 31 and reflects downward light of the light emitted by the point light source 2 toward the first and second incidence surfaces 31a and 31b. Since the point light source 2 is installed in the concave portion 32, the reflection member 9 is disposed to cover the concave portion 32 that accommodates the point light source 2.

Light L1′ of the light emitted by the point light source 2, which is incident to the first incidence surface 31a, is refracted at a large angle by the pattern formed on the first incident surface 31a with respect to the central axis C and emitted by the light guide body 31 in a lateral direction. Meanwhile, light L2′ of the light emitted by the point light source 2, which is incident to the second incident surface 31b, is generally emitted at a angle that varies within a small range, so that it is emitted by the light guide body 31 in a lateral direction. Here, since the point light source 2 and the light guide body 31 are circularly symmetric with respect to the central axis C, the lateral direction refers to a radial direction that is tilted at a large angle with respect to the central axis C, unlike in the first embodiment.

Light Li′ transmitted through the light guide body 31 is collimated upward by a collimating member. The collimating member includes the annular reverse prism sheet 33.

A plurality of annular reverse prisms are formed in a concentric circular pattern on a light incidence surface 33a of the annular reverse prism sheet 33. In other words, the annular reverse prism sheet 33 is disposed such that the light incidence surface 33a having the annular reverse prisms faces the refraction surface 31d of the light guide body 31.

The annular reverse prism sheet 33 collimates laterally incident light in a z direction by use of the annular reverse prisms formed on the light incidence surface 33a. Since the light Li′ transmitted through the light guide body 31 is incident to the annular reverse prism sheet 33 in a radial direction, an additional forward prism sheet is not required unlike in the first embodiment.

As described above, the light L1′ emitted by the point light source 2 is collimated through the annular light guide body 31 and the annular reverse prism sheet 33, so that light Lc′ may be within a predetermined range of azimuth.

FIG. 7 is a diagram showing a modified example, which illustrates a case where a plurality of light guide units, each of which is the same as shown in FIG. 5, are arranged.

Referring to FIG. 7, a plurality of light guide units 30 are arranged such that light emission surfaces of the light guide units 30 are on the same plane 50. In each of the light guide units 30, outer portions of a light guide body and annular reverse prism sheet may be formed in rectangular shapes so as to leave no space that is not to be lighted. In the present exemplary embodiment, the light guide bodies of the light guide units 30 may not only be formed separately or integrally molded. Similarly, the annular reverse prism sheets of the light guide units 30 may be prepared separately in a number equal to the number of the light guide bodies, but they also may be integrally formed. The plane 50 on which the light emission surfaces of the light guide units 30 are disposed may be a reverse surface of an LC panel as will be explained later.

As can be seen from the present modified example, the backlight unit consistent with the present invention can be easily expanded to a large-area surface illuminator. Therefore, when the backlight unit consistent with the present invention is used for a display device, a large-area display device can be easily fabricated as will be described later.

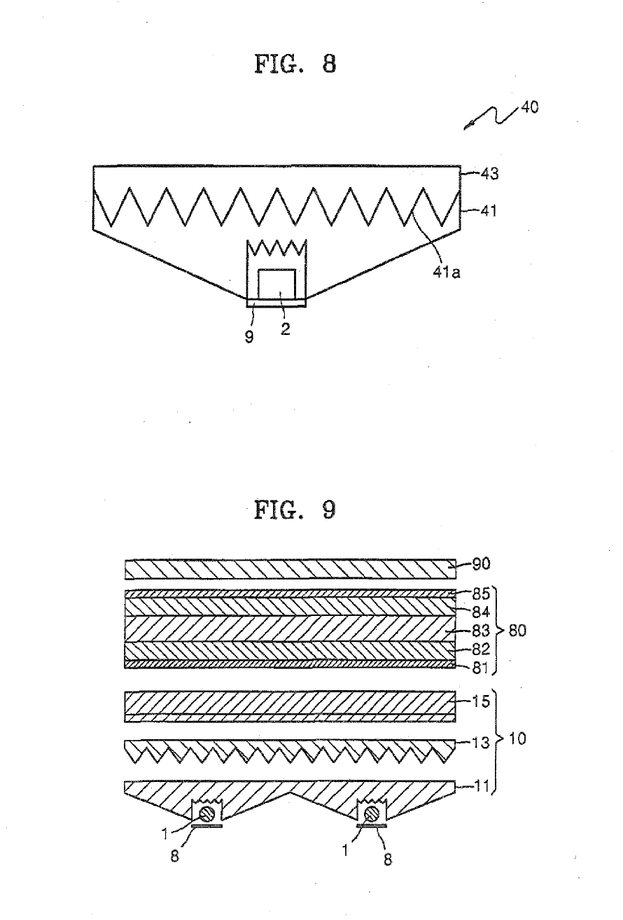

FIG. 8 is a lateral view of a light guide unit and a backlight unit using the same, according to yet another exemplary embodiment of the present invention.

Referring to FIG. 8, the backlight unit of the present exemplary embodiment includes a point light source 2, a light guide unit 40, which collimates light irradiated by the point light source 2 and performs surface-illumination, and a reflection member 9. The light guide unit 40 includes a light guide body 41, which accommodates the point light source 2, and an annular reverse prism sheet 43.

In the light guide unit 40 of the present exemplary embodiment, the light guide body 41 and the annular reverse prism sheet 43 are formed as an integral type. Specifically, a refraction surface 41a of the light guide body 41 has a complementary shape to a pattern of the reverse prism sheet 43 so that the light guide body 41 and the annular reverse prism sheet 43 are in mesh and adhered closely to each other. In this case, when light is transmitted from the light guide body 41 to the annular reverse prism sheet 43, the refractive index of the annular reverse prism sheet 43 may be higher than that of the light guide body 41 in order to prevent total reflection of the light.

As described above, by integrally forming the light guide body 41 and the annular reverse prism sheet 43, the total reflection of light transmitted from the refraction surface 41a of the light guide body 41 can be prevented. Further, the number of components assembled can be reduced, thus simplifying an assembling process of the backlight unit.

The light guide unit 40 of the present embodiment is substantially the same as the light guide unit shown in FIGS. 5 and 6 except that the light guide body 41 is combined with the annular reverse prism sheet 43. Therefore, a description of the remaining components will be omitted here.

Hereinafter, a display device according to an exemplary embodiment of the present invention will be described with reference to FIG. 9.

Referring to FIG. 9, the display device of the present exemplary embodiment includes an LC panel 80, which creates an image, and a backlight unit, which is prepared on a rear surface of the LC panel 80 and irradiates collimated light to the LC panel 80. Here, the backlight unit is a component having the main technical features of the present invention and includes a light source 1, a light guide unit 10, and a reflection member 8. Although the backlight unit described above with reference to FIGS. 1 through 3 is exemplarily illustrated in FIG. 9, the backlight unit of the present invention is not limited to the backlight unit including the light guide unit as described with reference to FIGS. 1 through 8 and can be modified in various forms. Thus, a detailed description of the backlight unit will be replaced by the description of the backlight unit as presented with reference to FIGS. 1 through 8.

The LC panel 80 is an example of a display panel that needs illumination. The LC panel 80 includes first and second transparent substrates 82 and 84, an LC layer 83, and first and second polarized light films 81 and 85. Specifically, the LC layer 83 is interposed between the first and second transparent substrates 82 and 84. The first polarized light film 81 is prepared as a polarizer on a rear surface of the first transparent substrate 82 such that only specific linearly polarized light of light emitted by the backlight unit 10 is incident on the LC layer 83. Also, the second polarized light film 85 is prepared as an analyzer on a front surface of the second transparent substrate 84.

The LC panel 80 displays an image based on the principle that the transmission rate of light depends on the alignment of LCs. In this case, a variation in the polarization of light varies with a direction in which the light is incident to the LC layer 83. The backlight unit of the present invention irradiates collimated light to the LC panel 80, so that a variation in the direction in which the light is incident to the LC layer 83 can be controlled to the minimum. For example, an azimuth of light collimated through the backlight unit may be restricted within 10°, thus elevating the contrast ratio of the LC panel 80. Further, as described above with reference to FIG. 7, a plurality of backlight units may be arranged on the same plane, so that a large-area display device using collimated light can be easily fabricated.

The display device of the present exemplary embodiment may further include a diffusion plate 90, which is prepared on a front surface of the LC panel 80. For example, a wide-angle diffuser, which has been disclosed in Korean Patent Application No. 2006-80718, filed on Aug. 24, 2006, by the present applicant, may be used as the diffusion plate 90. The diffusion plate 90 diffuses light, which is collimated and transmitted through the LC panel 80, to secure a sufficient view angle, so that the same image can be displayed in any direction.

Consistent with the present invention as explained thus far, the light guide unit and the backlight unit and display device using the light guide unit have the following effects.

First, a light source is installed in a concave portion of a light guide body so that loss of light can be minimized.

Second, a backlight unit is provided as a collimated surface light source, thereby improving the contrast ratio of the display device of the present invention.

Third, since a plurality of backlight units can be arranged on the same plane, a large-area surface light source can be easily fabricated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light guide unit comprising a light guide body that is formed of a transparent material and has at least one concave portion with a concavely depressed bottom surface to accommodate a light source, the light guide body comprising:
a first incidence surface forming a top surface of the concave portion, the first incidence surface patterned such that upwardly incident light is refracted at an oblique angle in a lateral direction;
a second incidence surface forming a lateral surface of the concave portion, the second incidence surface to which lateral light is incident;
a reflection surface disposed on a bottom surface of the light guide body, which extends from the concave portion; and
a refraction surface forming a top surface of the light guide body, the refraction surface through which incident light is refracted and transmitted.

2. The light guide unit of claim 1, wherein the concave portion forms an elongated groove to accommodate a line light source.

3. The light guide unit of claim 2, wherein the first incidence surface is patterned such that a plurality of elongated prisms are arranged in a lengthwise direction of the groove.

4. The light guide unit of claim 3, further comprising a collimating member prepared close to the refraction surface and which collimates light upward.

5. The light guide unit of claim 4, wherein the collimating member comprises:
a reverse prism sheet having a plurality of elongated linear prisms that are formed in the lengthwise direction of the groove on a surface that faces the refraction surface; and
a forward prism sheet disposed close to a light emission surface of the reverse prism sheet and having a plurality of elongated linear prisms that are formed in a direction perpendicular to the prisms of the reverse prism sheet on a rear surface facing away from a surface that faces the reverse prism sheet.

6. The light guide unit of claim 5, wherein the refraction surface has a complementary shape to a pattern of the reverse prism sheet so that the light guide body and the reverse prism sheet are in mesh and adhered closely to each other.

7. The light guide unit of claim 6, wherein the refractive index of the reverse prism sheet is higher than that of the light guide body.

8. The light guide unit of claim 1, wherein the concave portion forms one of a cylindrical groove and a polygonal columnar groove to accommodate a point light source.

9. The light guide unit of claim 8, wherein the first incidence surface is patterned such that a plurality of annular prisms are arranged in a concentric circular pattern.

10. The light guide unit of claim 9, further comprising a collimating member prepared close to the refraction surface and for collimating light upward.

11. The light guide unit of claim 10, wherein the collimating member includes an annular reverse prism sheet having a plurality of annular prisms that are formed in a concentric circular pattern on a surface that faces the refraction surface.

12. The light guide unit of claim 11, wherein the refraction surface has a complementary shape to the pattern of the annular reverse prism sheet so that the light guide body and the annular reverse prism sheet are in mesh and adhered closely to each other.

13. The light guide unit of claim 12, wherein the refractive index of the annular reverse prism sheet is higher than that of the light guide body.

14. The light guide unit of claim 1, wherein a portion outside of the concave portion of the light guide body is formed in a wedge shape so that a distance between the reflection surface and the refraction surface is greater in a region close to the concave portion than in a region far from the concave portion.

15. The light guide unit of claim 1, wherein the reflection surface is reflective-coated.

16. The light guide unit of claim 1, wherein the refraction surface is patterned such that transmitted light is refracted at an oblique angle in a lateral direction.

17. A backlight unit comprising:
a light source which irradiates light; and
at least one light guide unit which collimates the light irradiated by the light source to perform surface-illumination and including a light guide body, which is formed of a transparent material and has at least one concave portion with a concavely depressed bottom surface to accommodate the light source; and a collimating member which collimates the light transmitted through the light guide body,
wherein the light guide body comprises:
a first incidence surface forming a top surface of the concave portion, the first incidence surface patterned such that upwardly incident light is refracted at an oblique angle in a lateral direction;
a second incidence surface forming a lateral surface of the concave portion, the second incidence surface to which lateral light is incident;
a reflection surface disposed on a bottom surface of the light guide body, which extends from the concave portion; and
a refraction surface forming a top surface of the light guide body, the refraction surface through which incident light is refracted and transmitted.

18. The backlight unit of claim 17, wherein the concave portion forms an elongated groove to accommodate a line light source.

19. The backlight unit of claim 18, wherein the first incidence surface is patterned such that a plurality of elongated prisms are arranged in a lengthwise direction of the groove.

20. The backlight unit of claim 19, wherein the collimating member comprises:
a reverse prism sheet having a plurality of elongated linear prisms that are formed in the lengthwise direction of the groove on a surface opposite to the refraction surface; and
a forward prism sheet disposed close to a light emission surface of the reverse prism sheet and having a plurality of long linear prisms that are formed in a direction perpendicular to the prisms of the reverse prism sheet on a rear surface facing away from a surface that faces the reverse prism sheet.

21. The backlight unit of claim 20, wherein the refraction surface has a complementary shape to a pattern of the reverse prism sheet so that the light guide body and the reverse prism sheet are in mesh and adhered closely to each other.

22. The backlight unit of claim 21, wherein the refractive index of the reverse prism sheet is higher than that of the light guide body.

23. The backlight unit of claim 18, wherein the concave portion forms one of a cylindrical groove and a polygonal columnar groove to accommodate a point light source.

24. The backlight unit of claim 23, wherein the first incidence surface is patterned such that a plurality of annular prisms are arranged in a concentric circular pattern.

25. The backlight unit of claim 24, wherein the collimating member includes an annular reverse prism sheet having a plurality of annular prisms that are formed in a concentric circular pattern on a surface that faces the refraction surface.

26. The backlight unit of claim 25, wherein the refraction surface has a complementary shape to the pattern of the annular reverse prism sheet so that the light guide body and the annular reverse prism sheet are in mesh and adhered closely to each other.

27. The backlight unit of claim 25, wherein the refractive index of the annular reverse prism sheet is higher than that of the light guide body.

28. The backlight unit of claim 17, wherein the refraction surface is patterned such that transmitted light is refracted at an oblique angle in a lateral direction

29. The backlight unit of claim 17, wherein the reflection surface is aslant to the refraction surface such that a distance between the reflection surface and the refraction surface is greater in a region close to the concave portion than in a region far from the concave portion.

30. The backlight unit of claim 17, further comprising a reflection member disposed to cover the concave portion that accommodates the light source and for reflecting downward light toward the first and second incidence surfaces.

31. The backlight unit of claim 17, wherein a plurality of light guide units are arranged such that light emission surfaces of the light guide units are disposed on the same plane.

32. A display device comprising:
a display panel for creating an image; and
a backlight unit disposed on a rear surface of the display panel to irradiate collimated light on the display panel,
wherein the backlight unit comprises:
a light source which irradiates light; and
at least one light guide unit which collimates the light irradiated by the light source to perform surface-illumination and including a light guide body, which is formed of a transparent material and has at least one concave portion with a concavely depressed bottom surface to accommodate the light source; and a collimating member which collimates the light transmitted through the light guide body,
wherein the light guide body comprises:
a first incidence surface forming a top surface of the concave portion, the first incidence surface patterned such that upwardly incident light is refracted at an oblique angle in a lateral direction;
a second incidence surface forming a lateral surface of the concave portion, the second incidence surface to which lateral light is incident;
a reflection surface disposed on a bottom surface of the light guide body, which extends from the concave portion; and
a refraction surface forming a top surface of the light guide body, the refraction surface through which incident light is refracted and transmitted.

33. The display device of claim 32, wherein the concave portion forms an elongated groove to accommodate a line light source.

34. The display device of claim 33, wherein the first incidence surface is patterned such that a plurality of elongated prisms are arranged in a lengthwise direction of the groove.

35. The display device of claim 34, wherein the collimating member comprises:
a reverse prism sheet having a plurality of elongated linear prisms that are formed in the lengthwise direction of the groove on a surface that faces the refraction surface; and
a forward prism sheet disposed close to a light emission surface of the reverse prism sheet and having a plurality of elongated linear prisms that are formed in a direction perpendicular to the prisms of the reverse prism sheet on a rear surface facing away from a surface that faces the reverse prism sheet.

36. The display device of claim 35, wherein the refraction surface has a complementary shape to a pattern of the reverse prism sheet so that the light guide body and the reverse prism sheet are in mesh and adhered closely to each other.

37. The display device of claim 36, wherein the refractive index of the reverse prism sheet is higher than that of the light guide body.

38. The display device of claim 37, wherein the concave portion forms one of a cylindrical groove and a polygonal columnar groove to accommodate a point light source.

39. The display device of claim 38, wherein the first incidence surface is patterned such that a plurality of annular prisms are arranged in a concentric circular pattern.

40. The display device of claim 39, wherein the collimating member includes an annular reverse prism sheet having a plurality of annular prisms that are formed in a concentric circular pattern on a surface that faces the refraction surface.

41. The display device of claim 40, wherein the refraction surface has a complementary shape to the pattern of the annular reverse prism sheet so that the light guide body and the annular reverse prism sheet are in mesh and adhered closely to each other.

42. The display device of claim 41, wherein the refractive index of the annular reverse prism sheet is higher than that of the light guide body.

43. The display device of claim 32, wherein the refraction surface is patterned such that transmitted light is refracted at an oblique angle in a lateral direction

44. The display device of claim 32, wherein the reflection surface is aslant to the refraction surface such that a distance between the reflection surface and the refraction surface is greater in a region close to the concave portion than in a region far from the concave portion.

45. The display device of claim 32, further comprising a reflection member disposed to cover the concave portion that accommodates the light source and for reflecting downward light toward the first and second incidence surfaces.

46. The display device of claim 32, wherein a plurality of light guide units are arranged such that light emission surfaces of the light guide units are disposed on the same plane.

47. The display device of claim 32, further comprising a diffusion plate prepared on a front surface of the display panel and for diffusing light transmitted through the display panel.
